(19) United States
(12) Patent Application Publication
(10) Pub. No.: US 2026/0022739 A1
(43) Pub. Date: Jan. 22, 2026

(54) BEARING DEVICE WITH INTEGRATED ELECTRICAL INSULATION, IN PARTICULAR FOR AN ELECTRIC MOTOR OR MACHINE

(71) Applicant: AKTIEBOLAGET SKF, GOTEBORG (SE)

(72) Inventors: Benoit ARNAULT, Saint-Cyr-sur-Loire (FR); Mickael CHOLLET, Joué-Lès-Tours (FR)

(21) Appl. No.: 19/263,838

(22) Filed: Jul. 9, 2025

(30) Foreign Application Priority Data
Jul. 22, 2024 (FR) 2408028

(51) Int. Cl. F16C 41/00; F16C 19/06

(52) U.S. Cl. CPC F16C 41/002; F16C 19/06; F16C 2380/26

(57) ABSTRACT

A bearing device includes a bearing having first and second rings configured to rotate relative to each other about a central axis, a bushing and an electrically insulating insert overmolded between the second ring and the bushing. A maximum annular width of the second ring is less than a maximum axial width of the bushing, and a first annular side surface of the second ring is located axially inward of a first annular side surface of the bushing and a second annular side surface of the second ring is located axially inward of a second annular side surface of the bushing.

### CROSS-REFERENCE

This application claims priority to French patent application no. 2408028 filed on Jul. 22, 2024, the contents of which are fully incorporated herein by reference.

### TECHNOLOGICAL FIELD

The present disclosure relates to the field of bearings used in particular in electric motors, electric machines and associated equipment.

### BACKGROUND

In an electric motor or machine, at least one rolling bearing is mounted between the housing of the electric motor or machine and the rotary shaft, in order to support this shaft. During operation, when the shaft is rotating, a difference in electrical potential may occur between the shaft and the housing of the electric motor or machine, generating an electric current between the inner ring of the rolling bearing, which is rigidly secured to the shaft, and the outer ring, which is rigidly secured to the housing. The electric current passing through the components of the rolling bearing can damage these components, in particular the rolling elements and the raceways formed on the inner and outer rings. Electrical discharges can also cause vibrations.

To address these drawbacks, it is known in practice to replace the rolling elements of the bearing, originally made from the same steel as the inner and outer rings, with rolling elements made of ceramic. Such a bearing is commonly referred to as a hybrid rolling bearing. However, a hybrid rolling bearing of this kind is relatively expensive.

To further address the aforementioned drawbacks, it is also known in practice to equip the outer ring of the rolling bearing with an insulating sleeve comprising a bushing and an insulating liner made from an electrically insulating material and radially interposed between the outer ring and the bushing. In order to fix the insulating liner to the outer ring and the bushing without additional components or specific machining on the outer ring, it is possible to overmold the insulating liner. However, with a solution of this kind, relative separation of the insulating liner and the outer ring may occur during operation.

### SUMMARY

The present disclosure therefore aims to overcome the aforementioned drawbacks by providing a bearing device with a simple and economical design. The disclosure relates to a bearing device comprising a bearing having a first ring and a second ring that are configured to rotate relative to one another.

The device further comprises at least one insulating sleeve mounted on the second ring of the bearing. The insulating sleeve has a bushing and an insulating liner interposed radially between the second ring of the bearing and the bushing. The insulating liner is made of an electrically insulating material.

The bushing has an outer surface and an inner surface radially opposite the outer surface which delimit the radial thickness of the bushing. The bushing also has first and second axial end faces delimiting the axial length of the bushing.

The second ring has an outer surface and an inner surface radially opposite the outer surface which delimit the radial thickness of the second ring. The second ring also has first and second axial end faces delimiting the axial length of the second ring.

The insulating liner is overmolded on at least one of the outer and inner surfaces of the second ring and on at least one of the outer and inner surfaces of the bushing.

The first end face of the second ring and the first end face of the bushing are located axially on a first side relative to a median radial plane of the device. The second end face of the second ring and the second end face of the bushing are located axially on a second side relative to the median radial plane.

According to a general feature, the first end face of the second ring is axially offset towards the inside of the device relative to the first end face of the bushing. According to another general feature, the second end face of the second ring is axially offset towards the inside of the device relative to the second end face of the bushing.

According to yet another general feature, the insulating liner is also overmolded on the first and second end faces of the second ring.

The overmolding of the insulating liner on these first and second end faces ensures a strong bond with the second ring. The risk of relative movement between the insulating liner and the second ring in the axial direction is avoided, particularly in the event of temperature changes. The term “axial direction” refers to the direction parallel to the axis of the bearing device.

Moreover, having the first and second end faces of the second ring each set back axially relative to the first and second end faces of the bushing reduces the machining time of the device, since only the end faces of the bushing need to be ground. This also reduces the overall weight of the device, bearing in mind the shorter axial length of the second ring compared with that of the bushing.

The insulating liner having first and second end faces defining the axial length of the liner. According to a first design, at least one of the first and second end faces of the bushing may be axially flush with one of the end faces of the insulating liner. According to a second design, each of the first and second end faces of the bushing is axially flush with one of the end faces of the insulating liner. Alternatively, one of the end faces, or each end face, of the bushing may be axially offset towards the inside or towards the outside relative to the associated end face of the insulating liner.

The first ring comprises first and second end faces that delimit the axial length of the first ring. In one particular embodiment, the first and second end faces of the first ring may be coplanar (flush) with the first and second end faces of the bushing, respectively.

In one embodiment, the surface of the bushing comprises at least one protuberance that protrudes radially on the side of the second ring.

In another embodiment, the bushing is monobloc and comprises an axial portion delimiting the surface of the bushing on which the insulating liner is overmolded, and first and second flanges extending radially from the axial portion on the side of the second ring.

“Monobloc bushing” is taken to mean that the bushing is made in one continuous piece. The bushing is formed in one single part.

The insulating liner is further overmolded on an inner face of each of the first and second flanges of the bushing. The second flange of the bushing may extend radially beyond the surface of the second ring on which the insulating liner is overmolded. The first flange of the bushing may remain set back radially with respect to the outer surface of the second ring.

In another embodiment, the bushing is made of at least two separate parts. The two parts jointly delimit an axial portion that forms the surface of the bushing on which the insulating liner is overmolded, and each comprises a flange extending radially from the axial portion on the side of the second ring. The insulating liner is also overmolded on an inner face of each flange of each of the two parts of the bushing.

According to a particular design, the surface of the bushing having at least one groove extending in the circumferential direction, within which groove there extends a locking rib of the insulating liner with a complementary shape. Hence, the axial locking of the insulating liner on the bushing is further enhanced.

“Circumferential direction” is taken to mean the direction that is perpendicular to both the axial direction and to a radius of the bearing device, in other words tangential to a circle, the center of which lies on the axis of the bearing device.

If the insulating liner is made of synthetic material or elastomeric material, it renders the device less sensitive to temperature changes.

In one particular embodiment, the bushing is made of metallic material. The bushing can therefore be easily machined to a predetermined radial tolerance. The bushing is advantageously obtained from a sheet metal blank by cutting, pressing and rolling.

In one embodiment, the insulating liner covers the whole of the surface of the bushing. In this case, the insulating liner completely covers the surface of the bushing in the axial direction and in the circumferential direction.

According to a first design, the bushing delimits the outer surface of the device. In this case, the second ring is the outer ring of the bearing. According to a second alternative design, the bushing delimits the inner surface of the device. In this case, the second ring is the inner ring of the bearing.

According to an embodiment of the disclosure, a bearing device comprises a bearing, a bushing and an electrically insulating insert overmolded between and connecting the bushing and the bearing. The bearing includes a first ring and a second ring configured to rotate relative to each other about a central axis, the first ring and the second ring each having a first cylindrical surface and a second cylindrical surface radially spaced from the first cylindrical surface and a first annular side surface and a second annular side surface axially spaced from the first annular side surface and a maximum axial width. The bushing has a first cylindrical surface and a second cylindrical surface and a radial thickness from the first cylindrical surface of the bushing to the second cylindrical surface of the bushing and a first annular side surface and a second axial side surface axially spaced from the first annular side surface of the bushing and a maximum axial width. The electrically insulating insert has a first annular side surface and a second annular side axially spaced from the first annular side surface of the electrically insulating insert and a maximum axial width. The maximum axial width of the second ring is less than the maximum axial width of the bushing, the first annular side surface of the second ring is located axially inward of the first annular side surface of the bushing and the second annular side surface of the second ring is located axially inward of the second annular side surface of the bushing, and the first annular side surface of the bushing is coplanar with the first annular side surface of the first ring and/or the second annular side surface of the bushing is coplanar with the second annular side surface of the first ring.

In one particular embodiment, the bearing comprises at least one row of rolling elements arranged between raceways of the first and second rings. The rolling elements may be made of metallic material.

The disclosure also relates to an electric motor comprising a housing, a shaft and at least one bearing device as defined above, mounted radially between the housing and the shaft.

### BRIEF DESCRIPTION OF THE DRAWINGS

The present disclosure will be better understood on studying the detailed description of embodiments, provided by way of non-limiting examples and illustrated by the appended drawings, in which:

FIG. 1 is an axial sectional view of a bearing device according to an exemplary embodiment of the present disclosure.

FIG. 2 is an axial sectional view of a bearing device according to another exemplary embodiment of the present disclosure.

FIG. 3 is an axial sectional view of a bearing device according to another exemplary embodiment of the present disclosure.

FIG. 4 is an axial sectional view of a bearing device according to another exemplary embodiment of the present disclosure.

FIG. 5 is an axial sectional view of a bearing device according to another exemplary embodiment of the present disclosure.

### DETAILED DESCRIPTION

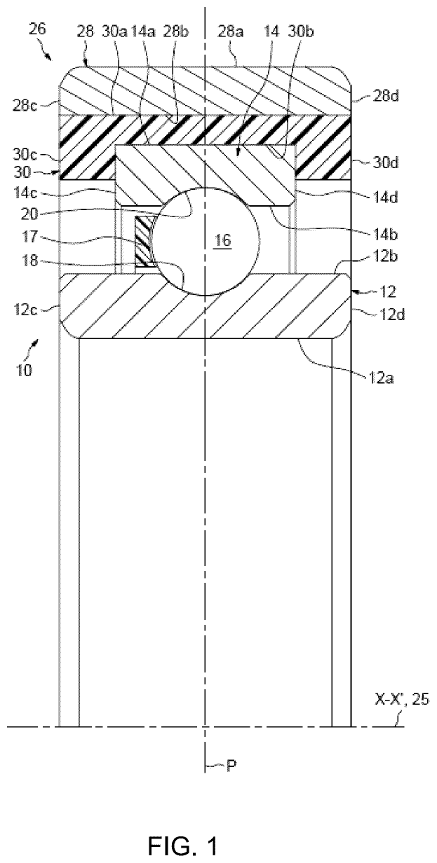

The bearing device illustrated in FIG. 1 comprises a bearing 10 having a first ring 12 and a second ring 14 that are configured to rotate relative to one another about the axis X-X′ of the bearing. In the exemplary embodiment illustrated, the first ring 12 is the inner ring of the bearing and the second ring 14 is the outer ring.

The bearing device is designed in such a manner as not to conduct electrical current. The bearing device has integrated electrical insulation.

The inner ring 12 and the outer ring 14 of the bearing are concentric and extend axially along the X-X′ axis of the bearing. The inner ring 12 and the outer ring 14 are made of solid steel. The rings are solid.

In the illustrated embodiment, the bearing 10 also comprises a row of rolling elements 16, in this case balls, interposed radially between the inner ring 12 and the outer ring 14. The rolling elements 16 are made of steel. The bearing 10 also comprises a cage 17 for maintaining regular circumferential spacing between the rolling elements 16. The bearing 10 may also be equipped with seals or sealing flanges.

The inner ring 12 comprises a cylindrical bore 12a, a cylindrical axial outer surface 12b radially opposite the bore and first and second radially opposite end faces 12c, 12d axially delimiting the bore and the outer surface. The bore 12a and the outer surface 12b delimit the radial thickness of the inner ring 12. The bore 12a forms the inner surface of the inner ring. The first and second end faces 12c and 12d delimit the axial length of the inner ring 12. The inner ring 12 further comprises an inner raceway 18 for the rolling elements 16 which is formed on the outer surface 12b. The raceway 18 is directed radially outwards.

The outer ring 14 comprises an cylindrical axial outer surface 14a, a cylindrical bore 14b radially opposite the outer surface 14a, and first and second radial end faces 14c, 14d axially delimiting the bore 14b and the outer surface 14a. The outer surface 14a and the bore 14b delimit the radial thickness of the outer ring 14. The first and second faces 14c and 14d delimit the axial length of the outer ring 14. The outer ring 14 further comprises an outer raceway 20 for the rolling elements 16 which is formed on the bore 14b. The raceway 20 is directed radially inwards.

The bearing device also comprises an electrically insulating sleeve 26 mounted on the outer ring 14. The insulating sleeve 26 is mounted on the outer surface 14a of the outer ring 14. The insulating sleeve 26 is rigidly secured to the outer ring 14. The insulating sleeve 26 comprises a bushing 28 and an insulating liner 30 interposed radially between the outer ring 14 and the bushing 28. The insulating liner 30 is overmolded on the outer ring 14 and on the bushing 28.

The bushing 28 is annular. The bushing 28 is monobloc. The bushing 28 in this case is made in one piece. The bushing 28 is preferably made of steel. The bushing 28 may be advantageously obtained from a tube or from forged and/or rolled blanks, or also by stamping.

The bushing 28 comprises a cylindrical annular axial outer surface 28a and a cylindrical annular axial bore 28b radially opposite the outer surface 28a. The bore 28b forms the inner surface of the bushing 28. The bore 28b is oriented radially inwards, i.e. on the side of the outer ring 14 and of the insulating liner 30. The axis 25 of the bore 28b is coaxial with the X-X′ axis. The outer surface 28a and the bore 28b delimit the radial thickness of the bushing 28. The outer surface 28a of the bushing delimits the outer surface of the bearing device 10. In other words, the outer surface 28a defines the outer diameter of the bearing device 10. The bushing 28 also comprises first and second opposite radial end faces 28c, 28d that delimit the bore and the outer surface axially. The end faces 28c, 28d delimit the axial length of the bushing.

The end faces 14c, 28c of the outer ring and of the bushing are located axially on a first side relative to a median radial plane P of the device and the end faces 14d, 28d of the outer ring and of the bushing are located axially on a second side relative to the median radial plane P which is opposite the first side. The median radial plane P passes through the center of the rolling elements 16 here.

The end face 14c of the outer ring is axially offset towards the inside relative to the end face 28c of the bushing. The end face 14d of the outer ring is axially offset towards the inside relative to the end face 28d of the bushing. In other words, the end faces 14c and 14d of the outer ring are axially set back from the end faces 28c, 28d of the bushing. The axial dimension of the outer ring 14 is less than the axial dimension of the bushing 28.

The end face 14c of the outer ring is axially offset towards the inside relative to the end face 12c of the inner ring. The end face 14d of the outer ring is axially offset towards the inside relative to the end face 12d of the inner ring.

The insulating liner 30 is made of an electrically insulating material. The insulating liner 30 may, for example, be made of a synthetic material, such as PEEK or PA46, or may also be made of an elastomeric material, for example rubber.

The insulating liner 30 is interposed radially between the outer surface 14a of the outer ring and the bore 28b of the bushing. The insulating liner 30 covers the outer surface 14a of the outer ring. The insulating liner 30 in this case covers the outer surface 14a of the outer ring with respect to the axial and circumferential directions. The insulating liner 30 also covers the end faces 14c, 14d of the outer ring.

The insulating liner 30 also covers the bore 28b of the bushing. The insulating liner 30 also in this case completely covers the bore 28b considering the axial and circumferential directions.

The insulating liner 30 is annular. The insulating liner 30 extends axially. The insulating liner 30 comprises a cylindrical axial outer surface 30a, a cylindrical bore 30b radially opposite the outer surface 30a and first and second radial end faces 30c and 30d axially delimiting the bore and the outer surface. The radial end faces 30c, 30d delimit the insulating liner 30 axially. The outer surface 30a and the bore 30b delimit the radial thickness of the insulating liner 30. The outer surface 30a is in radial contact with the bore 28b of the bushing. The bore 30b is in radial contact with the outer surface 14a and with the end faces 14c, 14d of the outer ring. The bore 30b has a stepped configuration.

The end face 14c of the outer ring is axially offset towards the inside relative to the end face 30c of the insulating liner. The end face 14d of the outer ring is axially offset towards the inside relative to the end face 30d of the insulating liner.

In the exemplary embodiment illustrated, the faces 30c, 28c and 30d, 28d of the insulating liner and of the bushing are coplanar, respectively. Alternatively, other configurations can be envisaged. For example, the bushing 28 could protrude axially beyond the insulating liner 30 relative to faces 30c and 30d, or remain axially set back from these faces.

In the exemplary embodiment illustrated, the faces 12c, 28c and 12d, 28d of the inner ring and of the bushing are coplanar, respectively. Alternatively, it is possible to envisage other configurations. For example, the bushing 28 could protrude axially beyond the faces 12c and 12d of the inner ring or remain axially set back from these faces.

To produce the bearing device, the following procedure is followed.

In a first step, the bushing 28 and the outer ring 14 of the bearing are mounted inside a mold which is provided for overmolding the insulating liner 30. Next, in a second step, the insulating liner 30 is overmolded both on the outer ring 14 and on the bushing 28. Then, in a third successive step, the unitary assembly made up of the outer ring 14, the bushing 28 and the insulating liner 30 is removed from the mold. Next, in a fourth step, the end faces 28c and 28d of the bushing are ground. At this stage, the outer surface 28a of the bushing and the raceway 20 of the outer ring may also be ground. Lastly, in a fifth step, the unitary assembly made up of the outer ring 14, the bushing 28 and the insulating liner 30 is assembled with the row of rolling elements 16, the cage 17 and the inner ring 12.

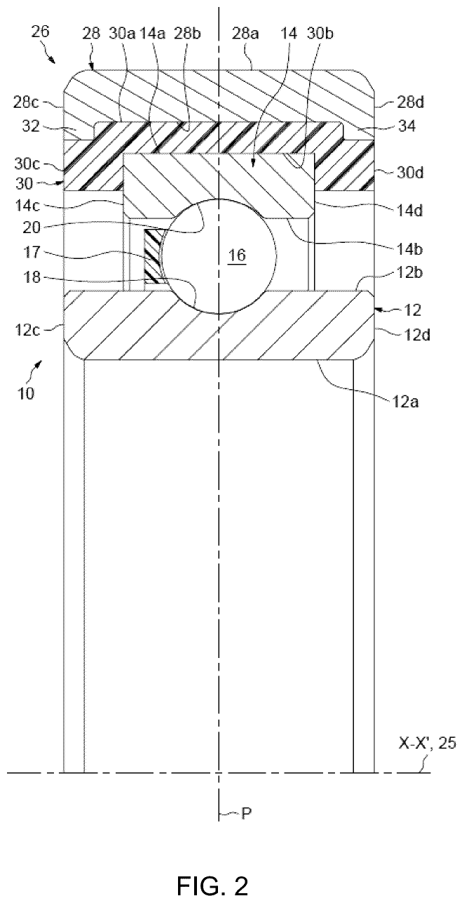

The exemplary embodiment illustrated in FIG. 2, in which identical elements bear the same reference signs, differs from the first example in that the bore 28b of the bushing comprises a first protuberance 32 that protrudes towards the inside, i.e. in the direction of the insulating liner 30. The protuberance 27 protrudes relative to the bore 32. The protuberance 32 extends radially.

The protuberance 32 is located at one axial end of the bore 28b of the bushing. The protuberance 32 extends radially towards the inside from the end face 28c of the bushing. The outer face of the protuberance 32 is coplanar with end face 28c.

In the illustrated embodiment, the bore 28b of the bushing also comprises, at its other axial end, a second protuberance 34 that protrudes towards the inside, i.e. in the direction of the insulating liner 30. The protuberance 34 protrudes relative to the bore 28b. The protuberance 34 extends radially. The protuberance 34 extends radially towards the inside from the end face 28d of the bushing. The outer face of protuberance 34 is coplanar with the end face 28d.

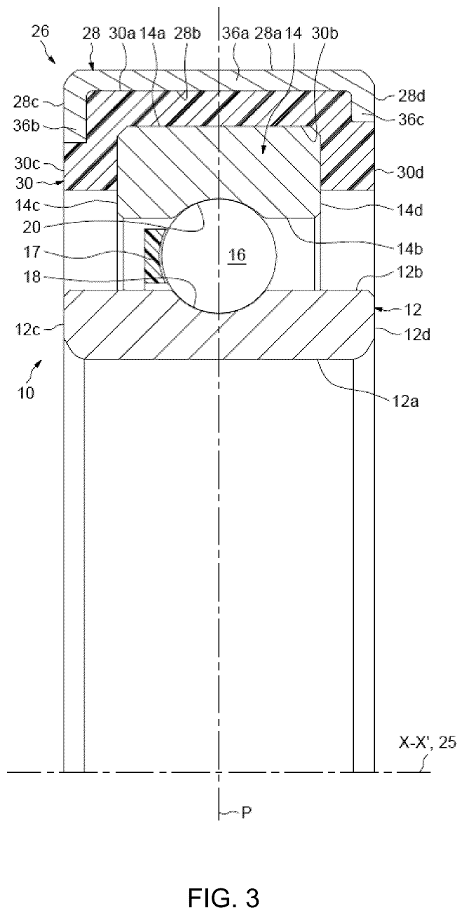

The exemplary embodiment illustrated in FIG. 3, in which identical elements bear the same reference signs, differs from the previous example in that the bushing 28 is obtained from a sheet metal blank by cutting, pressing and rolling. The bushing 28 is monobloc.

In this example, the bushing 32 comprises an axial portion 36a and first and second annular radial flanges 36b, 36c, each extending radially towards the inside from the axial portion. Each flange 36b, 36c extends radially. Each flange 36b, 36c extends from an axial end of the axial portion 36a. In the exemplary embodiment illustrated, the flanges 36b, 36c are annular. Alternatively, at least one of the flanges 36b, 36c could be implemented as sectors spaced apart from one another in the circumferential direction.

The end face 28c of the bushing is delimited by the flange 36b, and the end face 28d is delimited by the flange 36c. More accurately, the end face 28c is delimited by the outer face of the flange 36b, and the end face 28d is delimited by the outer face of the flange 36c. The insulating liner 30 also covers the inner face of each flange 36b, 36c of the bushing. The inner face and the outer face axially opposite the inner face of each flange 36b and 36c delimit the axial thickness of the flange. For each flange 36b and 36c, the inner face is oriented axially towards the inside of the device and the outer face is oriented axially towards the outside of the device. The insulating liner 30 also covers the free end of each flange 36b, 36c of the bushing.

The flange 36b of the bushing extends radially beyond the outer surface 14a of the outer ring, i.e. it projects radially towards the inside relative to the outer surface 14a. In other words, the free end of the flange 36b is offset radially towards the inside relative to the outer surface 14a of the outer ring.

The flange 36c of the bushing is set back radially from the outer surface 14a of the outer ring. In other words, the free end of the flange 36b is offset radially towards the outside relative to the outer surface 14a of the outer ring. The flanges 36b, 36c are spaced axially apart from the outer ring 14.

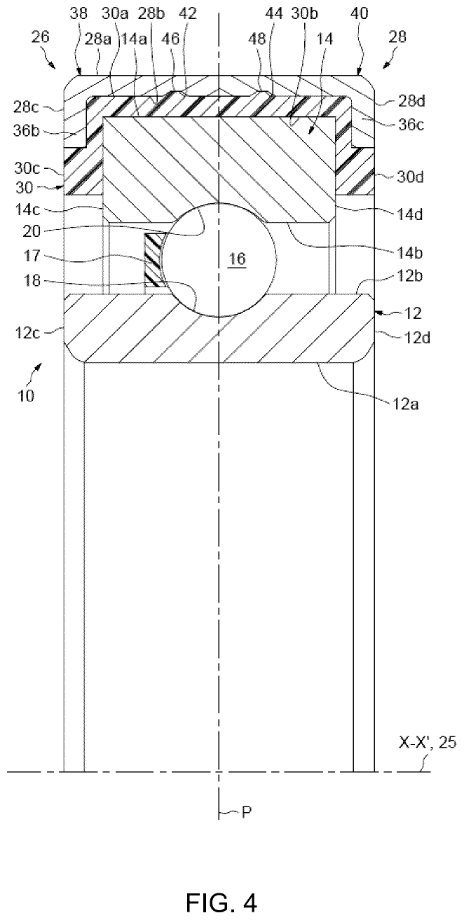

The exemplary embodiment illustrated in FIG. 4, in which identical elements bear the same reference signs, differs from the previous example primarily in that the bushing 28 is made of two distinct parts 38 and 40. These two separate parts 38, 40 form semi-flanges that bear against one another in this case axially. In the exemplary embodiment illustrated, parts 38 and 40 of the bushing are identical and symmetrical relative to the median radial plane P of the device, in order to reduce manufacturing costs. Alternatively, it is of course possible to envisage parts 38 and 40 that are non-symmetrical. In another variant, it could be possible to envisage that the bushing 28 is made up of more than two parts. The parts 38, 40 of the bushing 28 are preferably made of steel. The parts 38, 40 may advantageously be obtained from sheet metal by cutting, stamping, and rolling. Each part 38 or 40 of the bushing delimits part of the axial portion 36a and comprises one of the flanges 36b or 36c.

In the exemplary embodiment illustrated, the radial flanges 36b, 36c of the bushing extend radially beyond the outer surface 14a of the outer ring.

The bore of the axial portion 36a of the bushing having two axially spaced grooves 42, 44 which extend circumferentially around the axis 25 of the bore of the bushing. Each groove 42, 44 is oriented radially on the side of the outer ring 14, i.e. radially towards the inside. The groove 42 is formed on the part 38 of the bushing and groove 44 is formed on the part 40.

In the exemplary embodiment illustrated, each groove 42, 44 is annular. Alternatively, at least one of the two grooves 42, 44 may not extend over 360°, or may also be formed by a succession of spiral segments extending circumferentially and spaced apart from one another in the circumferential direction.

Each groove 42, 44 is delimited in the axial direction by two lateral flanks facing each other which have a straight profile in axial cross section and are connected to one another by an axial base. Alternatively, other shapes can also be envisaged, for example grooves having in cross section a circular-arc profile oriented towards the inside.

The insulating liner 30 also comprises two ribs 46 and 48 extending radially towards the outside from the outer surface 30a, each housed within one of the grooves 42 and 44 in the bushing. The rib 46, 48 is complementary in shape to the corresponding groove 42, 44. Each rib 46, 48 protrudes from the outer surface 30a of the insulating liner. Each rib 46, 48 is formed on the outer surface 30a during the overmolding of the insulating liner 30.

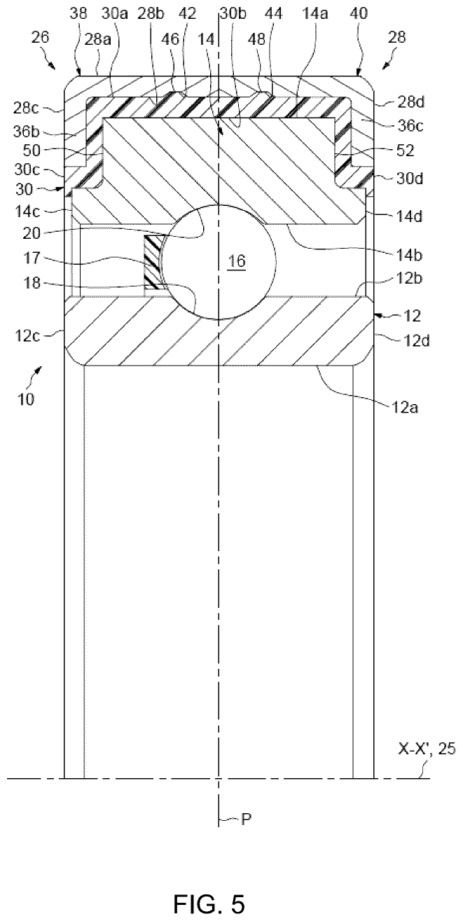

The exemplary embodiment illustrated in FIG. 5, in which identical elements bear the same reference signs, differs from the previous example primarily in that the outer ring 14 has an increased axial dimension.

The axial dimension of the outer ring 14 remains less than the axial dimension of the bushing 28. The end face 14c of the outer ring remains axially offset towards the inside with respect to the end face 28c of the bushing. The end face 14d of the outer ring remains axially offset towards the inside relative to the end face 28d of the bushing.

In the exemplary embodiment illustrated, a recess 50 is formed in the end face 14d of the outer ring. The recess 50 is oriented and opens axially towards the outside from the outer ring. The recess 50 has a bottom that is axially offset towards the inside of the ring relative to the remainder of the end face 14d. The bottom of the recess 50 forms a shoulder. For ease of manufacturing, the bottom of the recess 50 extends radially in this case. The recess 50 is annular in this embodiment. The flange 36b of the bushing extends partly into the recess 50 while remaining spaced apart from the outer ring 14.

Similarly, a recess 52 is formed in the end face 14c of the outer ring. The recess 52 is oriented and opens axially towards the outside from the outer ring. The recess 52 has a bottom that is axially offset towards the inside of the ring relative to the remainder of the end face 14c. The bottom of the recess 52 forms a shoulder. The bottom of the recess 52 extends radially in this case. The recess 52 is annular here. The flange 36c of the bushing extends partly into recess 52, while remaining spaced apart from the outer ring 14. The recesses 50 and 52 are symmetrical with respect to a radial median plane of the outer ring. The recesses 50, 52 delimit the outer surface 14a axially. The insulating liner 30 covers both recesses 50 and 52 of the outer ring.

In the exemplary embodiments illustrated, the first ring 12 of the bearing is the inner ring and the second ring 14 on which the insulating liner 30 is overmolded, is the outer ring.

Alternatively, an inverse arrangement may be provided, in which the second ring 14 on which the insulating liner 30 is overmolded is the inner ring. In this case, the insulating sleeve is located within the bore 12a of the inner ring. The insulating liner is then radially interposed between the bore 12a of the inner ring and the outer surface of the bushing. The insulating liner is overmolded at least on the inner surface of the inner ring and at least on the outer surface of the bushing. The bore of the bushing delimits the bore of the bearing device.

In the exemplary embodiments described, the bearing of the device having a single row of rolling elements. As a variant, the bearing may be having multiple rows of rolling elements. Furthermore, the rolling bearing may comprise types of rolling elements other than balls, such as rollers, for example. In another variant, the bearing may be a sliding bearing with no rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved insulated bearing devices.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other about a central axis, the first ring and the second ring each having a first cylindrical surface and a second cylindrical surface radially spaced from the first cylindrical surface and a first annular side surface and a second annular side surface axially spaced from the first annular side surface and a maximum axial width,
a bushing having a first cylindrical surface and a second cylindrical surface and a radial thickness from the first cylindrical surface of the bushing to the second cylindrical surface of the bushing and a first annular side surface and a second axial side surface axially spaced from the first annular side surface of the bushing and a maximum axial width, and
an electrically insulating insert overmolded between and connecting the bushing and the second cylindrical surface of the second ring, the electrically insulating insert having a first annular side surface and a second annular side axially spaced from the first annular side surface of the electrically insulating insert and a maximum axial width,
wherein the maximum axial width of the second ring is less than the maximum axial width of the bushing,
wherein the first annular side surface of the second ring is located axially inward of the first annular side surface of the bushing and the second annular side surface of the second ring is located axially inward of the second annular side surface of the bushing, and
wherein the first annular side surface of the bushing is coplanar with the first annular side surface of the first ring and/or the second annular side surface of the bushing is coplanar with the second annular side surface of the first ring.

2. The bearing device according to claim 1,
wherein the first annular side surface of the bushing is coplanar with the first annular side surface of the electrically insulating insert and/or the second annular side surface of the bushing is coplanar with the second annular side surface of the electrically insulating insert.

3. The bearing device according to claim 1,
wherein the first annular side surface of the bushing is coplanar with the first annular side surface of the electrically insulating insert and the second annular side surface of the bushing is coplanar with the second annular side surface of the electrically insulating insert.

4. The bearing device according to claim 3,
wherein the first cylindrical surface of the bushing faces the second cylindrical surface of the second ring and includes at least one radially extending protuberance.

5. The bearing device according to claim 3,
wherein the bushing is monobloc,
wherein the bushing includes a first radially extending flange extending toward the first ring and a second radially extending flange extending toward the first ring,
wherein the electrically insulating insert is overmolded to the first radially extending flange and to the second radially extending flange, and
wherein the second radially extending flange extends radially beyond the second cylindrical surface of the second ring and the first radially extending flange does not extend radially as far as the second cylindrical surface of the second ring.

6. The bearing device according to claim 3,
wherein the bushing comprises a first axial part connected to a second axial part at a joint,
wherein the first axial part defines a first portion of the second cylindrical surface of the bushing and includes a first flange extending radially toward the first ring,
wherein the second axial part defines a second portion of the second cylindrical surface of the bushing and including a second flange extending radially toward the first ring, and
wherein the electrically insulating liner is overmolded on the first flange and on the second flange.

7. The bearing device according to claim 3,
wherein the bushing is made of a metallic material.

8. The bearing device according to claim 3,
wherein the electrically insulating liner is made of synthetic material or elastomeric material.

9. An electric motor comprising:
a housing,
a shaft, and
a bearing device according to claim 3, mounted radially between the housing and the shaft.
